(19) United States
(12) Patent Application Publication
(10) Pub. No.: US 2020/0286169 A1
(43) Pub. Date: Sep. 10, 2020

(54) METHODS AND SYSTEMS FOR AUTOMATED REAL-TIME ONLINE DATA PROCESSING

(71) Applicant: FAIRSTONE FINANCIAL INC., Montreal (CA)

(72) Inventors: Pina Pinizzotto, Montréal (CA); Maria do Carmo Ruggeri Pucci, Montréal (CA); François Guy Côté, Montréal (CA); Michel Quintin, Montréal (CA); Susan Margaret Hale, Montréal (CA); Jean-Philippe Larochelle, Montréal (CA); Alessandra Chollet Moreira Alvarenga, Montréal (CA)

(21) Appl. No.: 16/798,884

(22) Filed: Feb. 24, 2020

Related U.S. Application Data
(60) Provisional application No. 62/926,083, filed on Oct. 25, 2019.
(60) Provisional application No. 62/815,867, filed on Mar. 8, 2019.

(51) Int. Cl. G06Q 40/02; H04L 29/06

(52) U.S. Cl. CPC G06Q 40/025; H04L 63/1433

(57) ABSTRACT

Systems and methods are provided for automated online real-time data processing are provided. The system has a front end server and a back end server that communicate electronically with a user device to automate online form processing. The front end server automates parts of user information entry and sends the user information to a back end server, which further processes the user information to obtain a response within a predetermined period, then relaying the response to the user device to allow further processing to be performed.

### CROSS-REFERENCE TO RELATED APPLICATIONS

This application claims the benefit of U.S. Provisional Patent Application No. 62/815,867, filed Mar. 8, 2019, and U.S. Provisional Patent Application No. 62/926,083, filed Oct. 25, 2019. The entire contents of U.S. Provisional Patent Application Nos. 62/815,867 and 62/926,083 are hereby incorporated by reference.

### FIELD

The described embodiments relate to methods and systems for automated real-time data processing.

### INTRODUCTION

The following is not an admission that anything discussed below is part of the prior art or part of the common general knowledge of a person skilled in the art.

There are many situations in which a consumer's eligibility for financial offers (e.g. loans, credit, financing offers) must be assessed. Often, these assessments rely on data from external assessment providers (e.g. credit bureaus). To ensure that the consumer's eligibility is fully and accurately assessed, it is important to capture sufficient information to accurately identify the consumer to the external assessment providers. However, acquiring and inputting the necessary consumer data can be a time-consuming and burdensome exercise. Verifying that consumer data is accurate can also introduce delays into the assessment process, particularly when mistakes occur such as errors in data input.

Furthermore, verifying the identity of the consumer applying for the financial offer is important in helping prevent fraud and identity theft. In-person identity authentication may address some of these concerns, however this introduces further delays into the assessment process. This also substantially reduces the flexibility of a user assessment process, since the consumer must present themselves at a retailer location in order to complete the application for the financial offer. As a result, many consumers may not follow through on an application for the offer.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In a first broad aspect, there is provided a method of automated real-time online data processing, the method comprising: providing a user data request page to a remote user device, wherein the user data request page is configured to prompt submission of user eligibility data from the user device; receiving the user eligibility data from the user device; sending the user eligibility data to a back end server to perform a user eligibility analysis; within a predetermined period, receiving an eligibility response based on the user eligibility analysis from the back end server; sending the eligibility response to the user device; when the eligibility response indicates that the user eligibility was successful within the predetermined period: sending a validation request to the user device; receiving a validation input from the user device or a merchant device; and notifying the user device of the validation; when the eligibility response indicates that the user eligibility was not successful within the predetermined period, forwarding the user eligibility data to an internal verification server for further analysis.

In some cases, the validation request includes a request to provide user identification; receiving an update from the merchant or merchant server based on a validation of an identification document; and notifying the user device of the validation.

In some cases, the method may include invoking an API call to an address server to verify an address component of the user eligibility data.

In some cases, the method may include sending the eligibility response to a CRM server or a record storage server, or both.

In some cases, the method may include sending at least a portion of the user eligibility data to an external evaluation server, and receiving an external eligibility assessment form the external evaluation server.

In some cases, the external evaluation server may be a credit analysis server, and the method may include receiving a creditworthiness evaluation from the credit analysis server.

In some cases, the method may include sending the identification data to a compliance server; receiving verification of the identification from the credit analysis server; receiving notification whether a decline block code is removed; when the decline block code is not removed, notifying the merchant server that validation is not successful; and, otherwise, when the decline block code is removed, notifying the merchant server that validation is successful.

In some cases, the method may include evaluating a cyber-security risk associated with a user device used to initiate the eligibility assessment, and adjusting the results of the user eligibility assessment in response to the determined cyber-security risk associated with the user device.

In some cases, the method may be performed between an eligibility assessment server and a remote user device. In some cases, the eligibility assessment server may also be in communication with one or more external eligibility servers.

In another broad aspect, there is provided an automated online real-time data processing system, the system comprising a front end server on a network connected to a user device, the front end server comprising a memory, at least one network interface, and a processor coupled to the memory for electronic communication therewith, the processor configured to: provide a user information page to receive user information from the user device; send the user information to a back end server to perform further processing; within a predetermined period, receiving a response based on the further processing from the back end server; send the response to the user device; when the response indicates that the further processing was successful within the predetermined period: send a request to the user device to provide identification; transmit a request to the user device for an identification document; receive an update from the compliance server based on a validation indication received by the compliance server from the merchant or merchant server; and notify the user device of the validation; and, otherwise, when the response indicates that the further processing was not successful within the predetermined period, and additional processing of the user information is to be performed, send an indication of the user information to an internal verification server.

In some cases, the processor is further configured to invoke an API call to an address server to verify an address component of the user information.

In some cases, the processor is further configured to send the response to a CRM server, a record storage server, or both.

In some cases, the processor is further configured to send the name and address to a credit analysis server; and receive from the credit analysis server results of a hard check pull from a credit bureau.

In some cases, the system comprises a merchant or merchant server configured to send the identification to an compliance server; the back end server configured to receive verification of the identification from the credit analysis server, receive notification whether a decline block code is removed, when the decline block code is not removed, the back end server is configured to notify the merchant server that validation is not successful, and, otherwise, when the decline block code is removed, the back end server is configured to notify the merchant server that validation is successful.

It will be appreciated by a person skilled in the art that a data processing system and/or data processing method may include any one or more of the features contained herein and that the features may be used in any particular combination or sub-combination suitable for a data processing system and/or data processing method.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of an eligibility assessment computer network system in accordance with at least some embodiments;

FIG. 2 is a block diagram of a user eligibility assessment system in accordance with at least some embodiments;

FIG. 3 is a flowchart illustrating a method of determining user eligibility in accordance with at least some embodiments;

FIG. 4 is a block diagram of an example data processing system in accordance with at least some embodiments;

FIGS. 5A to 5D are flowchart diagrams illustrating an example data processing method in accordance with at least some embodiments;

FIG. 6A is a screenshot depiction of an example user interface in accordance with at least some embodiments;

FIG. 6B-6E are screenshot depictions of an example user identification interface in accordance with at least some embodiments;

FIGS. 7A and 7B are screenshot depictions of an example contact information entry user interface in accordance with at least some embodiments;

FIGS. 8A and 8B are screenshot depictions of the example contact information entry user interface of FIGS. 7A and 7B, when completed;

FIGS. 8C and 8D are screenshot depictions of an example of alternate demographic data entry user interfaces when completed, in accordance with at least some embodiments;

FIG. 9 is a screenshot depiction of an example address entry user interface in accordance with at least some embodiments;

FIG. 10 is a screenshot depiction of the example address entry user interface of FIG. 9, at a first stage;

FIGS. 11A and 11B are screenshot depictions of the example address entry user interface of FIGS. 9 and 10 at a second stage;

FIGS. 12A and 12B are screenshot depictions of the example address entry user interface of FIGS. 9 to 11B, when completed;

FIG. 13 is a screenshot depiction of an example validating information user interface in accordance with at least some embodiments;

FIGS. 14A and 14B are screenshot depictions of an example approval user interface in accordance with at least some embodiments;

FIGS. 15A and 15B are screenshot depictions of the example approval user interface of FIGS. 14A and 14B, when completed; and

FIG. 16 is a screenshot depiction of an example identity validation notification user interface in accordance with at least some embodiments.

The drawings, described or referred to below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXEMPLARY EMBODIMENTS

Various systems or methods will be described below to provide an example of an embodiment of the claimed subject matter. No embodiment described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an embodiment that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming. Accordingly, the program code may be written in C, C++ or any other suitable programming language and may comprise modules or classes, as is known to those skilled in object oriented programming. Alternatively, or in addition thereto, some of these elements implemented via software may be written in assembly language, machine language, or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific, and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

In many cases, merchants and retailers must assess the eligibility or credit-worthiness of consumers applying for financial offers. For example, many merchants offer their own (e.g., private) credit cards. Typically, a merchant receives a paper or online application form from a consumer. The merchant then verifies the information, conducts a credit check, and decides whether or not to approve the application. However, offering private credit cards can be a burdensome task for a retailer, as integrating paper or online consumer applications into the merchant's network may be difficult. Additionally, the often manual process of ingesting and validating consumer data introduces delays into the evaluation of consumer eligibility. As a result, retailers must dedicate additional resources into the data collection and validation process and away from their normal business. The delays may also discourage some consumers from following through on the application process.

In some cases, merchants may engage the services of banks or private lenders who offer white label solutions to conduct transactions as well as evaluate consumer eligibility. These solutions can employ white label payment gateways, which may include transaction hosting, merchant portals, and application programming interface (API) integration. These white label solutions may help merchants simplify the process of evaluating consumer credit-worthiness. However, retailers often lack control over the processing and security of consumer data. Delays can also be introduced because of the need to connect to a third-party financial processing gateway.

Embodiments described herein may facilitate the process of evaluating consumer eligibility for one or more financial offers. In particular, embodiments described herein may enable some or all of the consumer eligibility process to be automated. This may provide a more efficient and streamlined process for assessing eligibility, reducing the amount of time required for a consumer to apply and receive an eligibility determination. This streamlined process may, in turn, encourage more consumers to follow through with the process of applying for a financial offer.

Embodiments described herein may also provide increased flexibility for processes used to assess consumer eligibility. In particular, embodiments described herein may enable consumer identification to be submitted and validated digitally. This may allow users to complete the application process and receive an eligibility assessment without having to present themselves to a merchant in-person. At the same time, embodiments described herein may incorporate cyber-security risk assessments when user eligibility assessments are conducted digitally. This may help mitigate risks associated with potential user fraud.

Embodiments described herein may provide automated and real-time processing of form data over a network. For example, consumer information used to establish user identity and perform a user eligibility assessment may be conducted remotely over one or more networks.

Systems and methods described herein may facilitate user eligibility assessments, such as online credit card applications, credit risk evaluations, and credit ceiling calculations etc. through remote user devices. In some examples, existing manual processes can be augmented and/or replaced. An eligibility assessment system may automatically evaluate user eligibility for one or more financial offers (e.g. by evaluating creditworthiness) in real-time and without the intervention of a human operator. By providing automated assessments of user eligibility, organizations may be able to better allocate computing and security resources. This may provide financial benefits, in terms of increasing sales conversion because of the increased efficiency of the assessment process. This may also allow user data to be handled in a secure manner, by leveraging existing user accounts that are secured. As well, the systems and methods described herein may allow retailers to implement consumer eligibility assessment with reduced infrastructure, by leveraging the resources of existing user accounts and allowing users to provide data through their own devices.

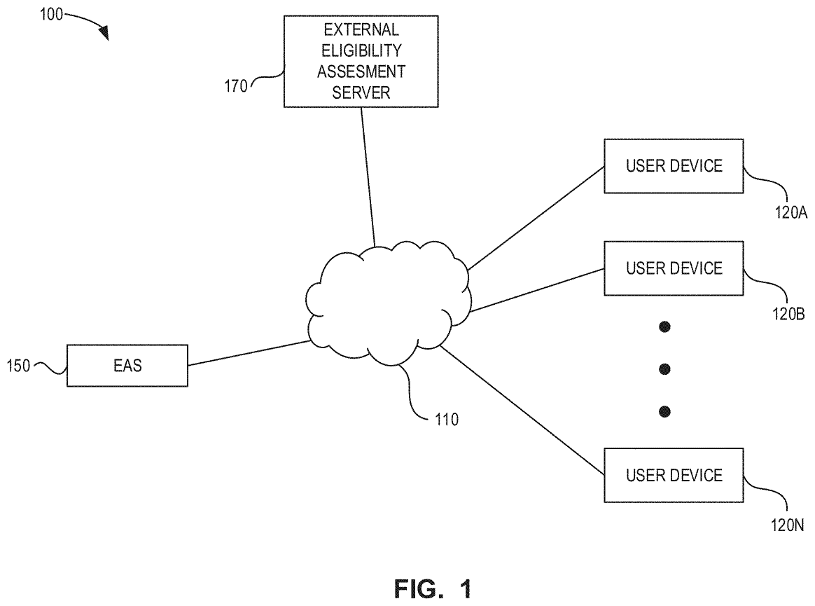

Referring now to FIG. 1, shown therein is a block diagram of an example consumer eligibility assessment computer network system 100 in accordance with an embodiment. Eligibility assessment system 100 is configured to collect and analyze user eligibility data for one or more user devices 120A-120N.

Computer network system 100 generally comprises a plurality of computers connected via data communication network 110, which itself may be connected to the Internet. In the example illustrated in FIG. 1, the computer network system 100 includes an eligibility assessment server (EAS) 150, a plurality of user devices 120A-120N (each comprising one or more computing devices), and one or more external eligibility assessment servers 170 connected via network 110.

Typically, the connection between network 110 and the Internet may be made via a firewall server (not shown). In some cases, there may be multiple links or firewalls, or both, between network 110 and the Internet. Some organizations may operate multiple networks 110 or virtual networks 110, which can be internetworked or isolated. These have been omitted for ease of illustration, however it will be understood that the teachings herein can be applied to such systems. Network 110 may be constructed from one or more computer network technologies, such as IEEE 802.3 (Ethernet), IEEE 802.11 and similar technologies.

Computers and computing devices may be connected to network 110 or a portion thereof via suitable network interfaces. Computing devices may also encompass any connected or “smart” devices capable of data communication, such as thermostats, refrigerators, air quality sensors, industrial equipment and the like. Increasingly, this encompasses a wide variety of devices as more devices become networked through the “Internet of Things”. In some cases, one or more of the computing devices such as the user devices 120 may connect to network 110 via the Internet.

Examples of computers include the eligibility assessment server 150, such as a desktop or server computer which can connect to network 110 via a wired Ethernet connection or a wireless connection. The eligibility assessment server 150 may also connect to the network 110 via the Internet. The eligibility assessment server 150 has a processor, volatile memory and non-volatile storage memory, at least one network interface, and may include input devices such as a keyboard and trackpad, output devices such as a display and speakers, and various other input/output devices as will be appreciated.

As with all devices shown in computer network system 100, there may be multiple assessment servers 150, although not all are shown. For instance, each user device 120 may communicate with a separate eligibility assessment server 150. Alternately or in addition, user devices 120 may communicate with different eligibility assessment servers 150 based on geographic location and/or network traffic constraints.

The user devices 120 can include various computing devices, such as smartphones, desktop, laptop or tablet computers, however the computing devices may also include a wide variety of “smart” devices capable of data communication. Like server 150, the user devices 120 have a processor, volatile and non-volatile memory, at least one network interface, and input/output devices. Each of the computers and computing devices may at times connect to external computers or servers via the Internet.

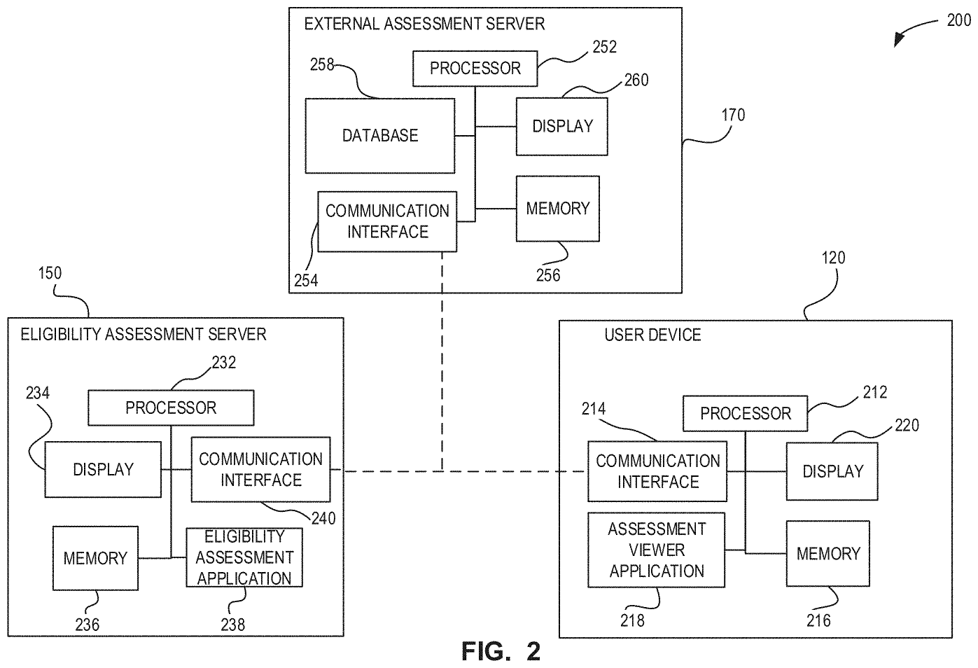

External eligibility assessment server 170 is a computer or computer server, and has a processor, volatile and non-volatile memory, at least one network interface, and may have various other input/output devices. As shown, external eligibility assessment server 170 is linked to network 110. However, in other embodiments, eligibility assessment server 170 may be outside network 110 and linked to the Internet. The eligibility assessment server 150, user device 120 and external eligibility assessment server 170 are described in greater detail with reference to FIG. 2 below.

Eligibility assessment server 150 may be configured to collect, analyze, and monitor consumer eligibility data associated with one or more consumers. Each consumer may be associated with one of the user devices 120. The consumer may interact with the user device 120 in order to initiate and receive a user eligibility assessment.

Eligibility assessment server 150 may collect user eligibility data associated with a consumer. For example, eligibility assessment server 150 may collect consumer demographic data, consumer financial information, consumer credit data, consumer historical credit data and so on associated with a user of a particular user device 120.

Eligibility assessment server 150 can also receive an eligibility assessment request from the user device 120. The eligibility assessment request may specify a financial offer. The eligibility assessment request can request that the consumer's eligibility for participating in the financial offer be evaluated by the eligibility assessment server 150.

The eligibility assessment server 150 can use the eligibility data associated with the consumer to evaluate the consumer's eligibility for the financial offer. The eligibility assessment server 150 can store eligibility criteria and/or eligibility assessment models used to determine an eligibility response. The eligibility assessment server 150 can apply the eligibility criteria and/or model to the user eligibility data to generate the eligibility response for the consumer. The eligibility assessment server 150 can then provide the eligibility response to the user device 120. Alternately or in addition, the eligibility assessment server 150 may provide the eligibility response to a retailer providing, or otherwise associated with, the financial offer.

In some cases, eligibility assessment server 150 may receive eligibility data directly from the user device 120. For example, a user may provide eligibility data through one or more user interfaces displayed by the user device 120. In some cases, the user may interact with the user interfaces to provide the user eligibility data, e.g. through data collection forms displayed on user device 120.

Alternately or in addition, the user device 120 may acquire user eligibility data by capturing and parsing an image of user data, e.g. an image of a user identification card such as a driver's license. This may allow the eligibility assessment server 150 to acquire the user eligibility data more rapidly. This may also assist in the process of authenticating a user requesting an assessment.

In some cases, the user device 120 may be configured to acquire eligibility data from one or more external servers, such as eligibility assessment servers 170. For example, the user device 120 may communicate with a server managing an existing account corresponding to the user to retrieve eligibility data to be provided to the eligibility assessment server 150.

Alternately or in addition, eligibility assessment server 150 may communicate with one or more external eligibility assessment servers 170 to retrieve some or all of the eligibility data associated with a user of a user device 120.

Alternately or in addition, eligibility assessment server 150 may store consumer data associated with one or more consumers having previously interacted with eligibility assessment server 150. This may facilitate subsequent consumer eligibility evaluations.

Referring now to FIG. 2, there is shown a block diagram of an eligibility assessment system 200 in accordance with an example embodiment. Eligibility assessment system 200 illustrates a detailed example of eligibility assessment server 150, external eligibility assessment server 170 and a user device 120 of network 100 shown in FIG. 1.

In some cases, the external eligibility assessment server 170 may be omitted from eligibility assessment system 200, for instance where no external eligibility assessment data is required. In some other cases, the external eligibility assessment server 170 and EAS 150 may be integrated or co-located.

Typically, the EAS 150 will be in communication with a plurality of user devices 120. Each of the computing devices 120 can be associated with users requesting eligibility assessments.

In some cases, a user computing device 120 may be associated with a merchant or retailer. For instance, a retailer may provide a user computing device 120 that is accessible to consumers at the retailer location. A consumer may access the retailer user device at the retailer location to initiate an eligibility assessment.

Initiating an eligibility assessment using a retailer user computing device 120 may automatically link the eligibility assessment to offers available from the corresponding retailer. This may further streamline the application process for assessments initiated at a retailer location, while still leveraging the resources of the eligibility assessment server 150.

EAS 150 may be directly linked to external eligibility assessment server 170, for example, via a Universal Serial Bus, Bluetooth™ or Ethernet connection. Alternatively, EAS 150 may be linked to external eligibility assessment server 170 via network 110 or, in some cases, the Internet. EAS 150 may also be linked to computing devices 120 via network 110 or, in some cases, the Internet.

EAS 150 has a processor 232, a display 234, a memory 236, a communication interface 240 and an eligibility assessment application 238. Although shown as separate elements, it will be understood that eligibility assessment application 238 may be stored in memory 236.

As used herein, the term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs. For example, for many organizations, important applications and services rely on regular input from spreadsheets that may be obtained from third parties, so these spreadsheets may be identified as software applications.

Processor 232 is a computer processor, such as a general purpose microprocessor. In some other cases, processor 232 may be a field programmable gate array, application specific integrated circuit, microcontroller, or other suitable computer processor.

Processor 232 is also coupled to display 234, which is a suitable display for outputting information and data as needed by various computer programs. In particular, display 234 may display a graphical user interface (GUI). In some cases, the display 234 may be omitted from eligibility assessment server 150, for instance where the eligibility assessment server 150 is configured to operate autonomously. In such cases, the EAS 150 may be configurable using a computer such as an administrator computer or user device 120 having administrator privileges that is connected to the EAS 150. EAS 150 may execute an operating system, such as Microsoft Windows™, GNU/Linux, or other suitable operating system.

Communication interface 240 is one or more data network interface, such as an IEEE 802.3 or IEEE 802.11 interface, for communication over a network.

Processor 232 is coupled, via a computer data bus, to memory 236. Memory 236 may include both volatile and non-volatile memory. Non-volatile memory stores computer programs consisting of computer-executable instructions, which may be loaded into volatile memory for execution by processor 232 as needed. It will be understood by those of skill in the art that references herein to EAS 150 as carrying out a function or acting in a particular way imply that processor 232 is executing instructions (e.g., a software program) stored in memory 236 and possibly transmitting or receiving inputs and outputs via one or more interface. Memory 236 may also store data input to, or output from, processor 232 in the course of executing the computer-executable instructions.

The memory 236 on RAS 105 may store a software application referred to herein as an eligibility assessment application 238. The eligibility assessment application 238 may be configured to collect user eligibility data and identify user risks associated with a user corresponding to user device 120. The eligibility assessment application 238 can be configured to determine and monitor eligibility assessment scores for a requesting user.

Memory 236 may also store one or more databases. The databases can store user eligibility data associated with one or more users.

For example, the database may store a user profile for each user having requested a user eligibility assessment. The user profile may contain user demographic data. The user profile may also include past or historical assessment data, representing the result of previous user assessments. The data stored in each user profile may be used by the eligibility assessment application 238 in generating an eligibility assessment for a requesting user.

Alternately or in addition, the database(s) may store eligibility criteria that can be used by the eligibility assessment application 238 to generate user eligibility assessments.

The eligibility criteria may include global criteria. Typically, global criteria apply generally to all eligibility assessment.

The eligibility criteria may include retailer-specific criteria. The retailer-specific criteria may apply specifically to all eligibility assessment associated with a particular retailer or set of retailers. For example, a particular retailer may define a risk threshold criteria that can be used for eligibility assessments associated with that particular retailer.

The eligibility criteria may include offer-specific criteria. The offer-specific criteria may apply specifically to all eligibility assessment associated with a particular offer or set of offers. For example, a retailer may define an offer restriction criteria that can be used for eligibility assessment associated with that particular offer. This may be used, for example, to restrict a particular offer to new consumers or existing consumers.

The eligibility criteria may include demographic-specific criteria. The demographic-specific criteria may apply specifically to all eligibility assessment for users associated with particular demographic data. For example, certain offers and/or certain types of offers may be limited to users from defined geographic areas or users of particular age-groups.

In some cases, the eligibility criteria may depend on external factors, such as interest rates. The databases can include dependent eligibility criteria that depend on these external. The EAS 150 may be configured to automatically monitor the external factors and update these dependent criteria based on changes to the external factors.

In some cases, the databases and/or eligibility assessment application 238 may store one or more eligibility assessment models. The eligibility assessment models can use the user eligibility data and/or eligibility criteria to generate an eligibility assessment for a requesting user.

Alternately or in addition, some or all of the database data may be stored by one or more external computing devices, such as external eligibility assessment server 170.

User device 120 is generally a computer such as a desktop computer, laptop computer, smartphone or tablet or other “smart” device (e.g. a smart watch, smart TV, a gaming console etc.) that may be networked through the “Internet of Things”. User device 120 has a processor 212, a communication interface 214 for data communication with communication interfaces 240 and 254, a display 220 for displaying a various GUIs, such as data collection and assessment result reporting GUIs for example, and a memory 216 that may include both volatile and non-volatile elements. As with EAS 150, references to acts or functions by computing device 120 imply that processor 212 is executing computer-executable instructions (e.g., a software program) stored in memory 216.

For instance, an assessment viewer application 218 may operate on the computing device 120. Although shown separately from memory 216, it will be understood that assessment viewer application 218 may be stored in memory 216. The assessment viewer application 218 may communicate with the eligibility assessment application 238 of EAS 150 to assist the EAS 150 in collecting user data, collecting eligibility assessments of user data, and providing feedback to users regarding eligibility assessment scores. Although in the example of FIG. 2 the assessment viewer application 218 is shown as installed on computing device 215, the assessment viewer application 218 may be otherwise accessible to the user device 120 for instance as a cloud application accessible to the user device 120 over a network such as the Internet. In some cases, the assessment viewer application 218 may be a webpage or web-based application accessible by the user through a browser application operating on user device 120.

The eligibility assessment application 238 of EAS 150 may acquire consumer eligibility data remotely from the user device 120, e.g. using the assessment viewer application 218. The assessment viewer application 218 may provide one or more user input interfaces usable by a user to enter and/or acquire consumer eligibility data. A user may interact with the user input interfaces through the user device 120 to provide some or all of the consumer eligibility data.

In some cases, the assessment viewer application 218 may provide an interface between the user device 120, EAS 150 and an external application or server usable to provide and/or retrieve user eligibility data. For example, the assessment viewer application 218 may interface with online financial applications associated with an existing user account corresponding to the user of user device 120. The user may interact with the assessment viewer application 218 to provide the EAS 150 with access to consumer eligibility data stored within, or in association with, the existing user account. This may facilitate the process of collecting and authenticating some or all of the user eligibility data.

The assessment viewer application 218 may also display notifications generated by EAS 150, e.g. to collect additional consumer eligibility data, to prompt the user to authenticate user eligibility data, and/or provide the results of the consumer eligibility assessment.

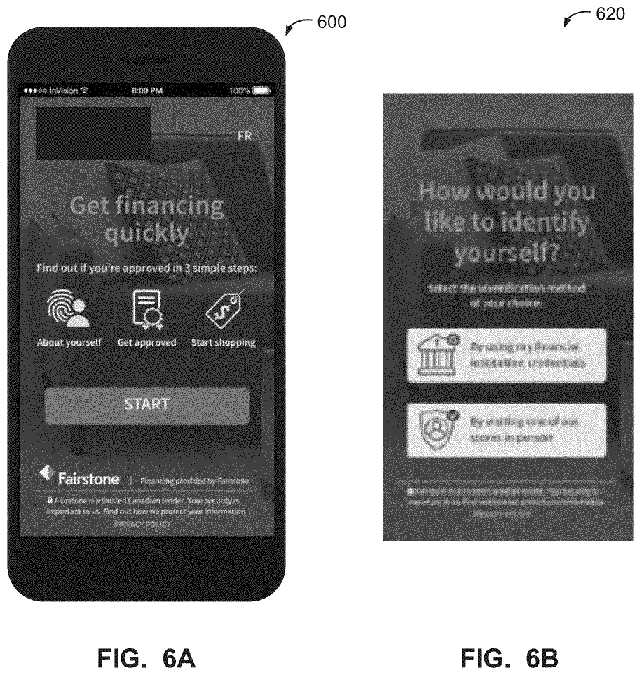

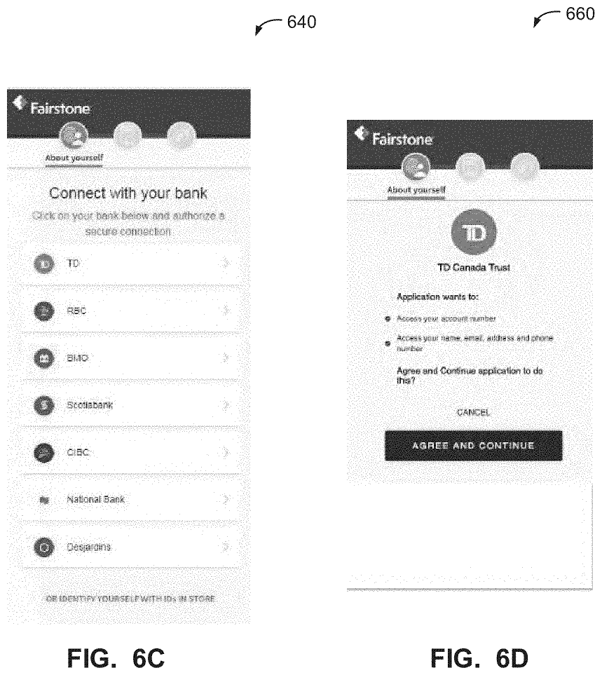

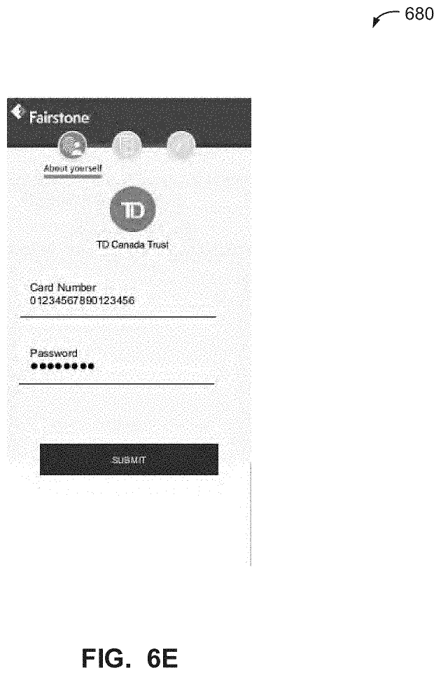

Examples of graphical user interfaces that may be displayed by assessment viewer application 218 using display 220 are shown in FIGS. 6A to 16.

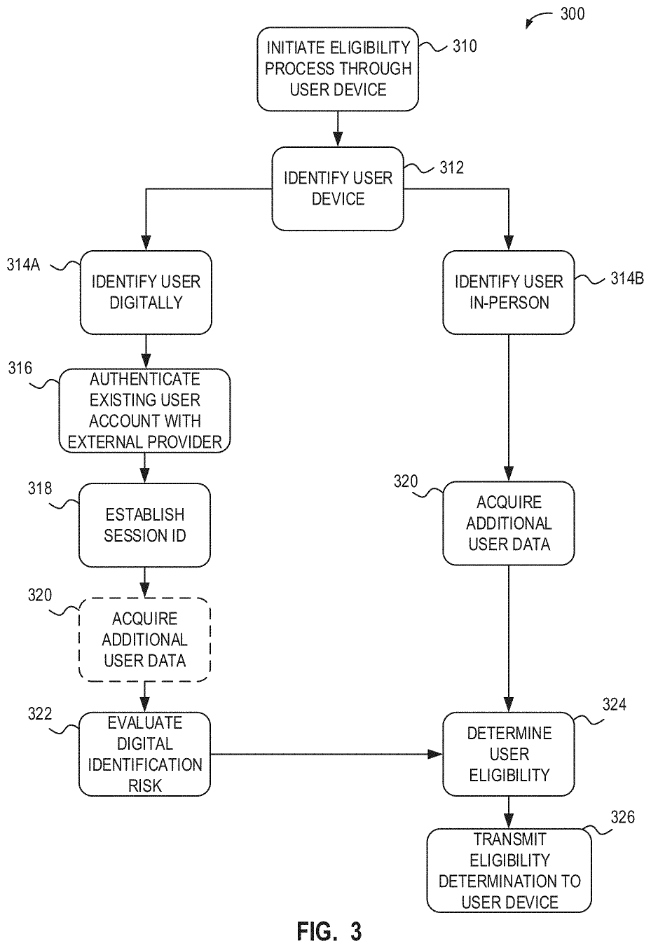

Referring to FIG. 3, shown therein is a flowchart of an example data processing method 300. Method 300 may be carried out by various components of systems 100 and 200, such as the EAS 150 and the user device 120.

At 310, a user can initiate an eligibility assessment through a user device 120. The user may access an eligibility viewer application 218 on the user device 120 in order to initiate the eligibility assessment.

In some cases, the eligibility viewer application 218 may be provided locally on the user device 120. For example, a retailer user device 120 may have the eligibility viewer application 218 installed on the retailer user device. This may facilitate initiating an eligibility assessment at a retailer location.

The user may initiate the user eligibility assessment by launching the eligibility viewer application 218 on the user device 120. The eligibility viewer application 218 may provide an initiation interface such as GUI 600 shown in FIG. 6A. A user can then interact with the initiation interface in GUI 600 to initiate the eligibility assessment.

In some cases, the eligibility assessment can be initiated through a user device 120 by navigating to an eligibility assessment website. For example, a user may navigate to a website provided by the eligibility assessment server 150 using a browser application on device 120. A user may initiate the eligibility assessment by selecting a button or link on the eligibility assessment website.

In some cases, a user may initiate the eligibility assessment by selecting a link, visual content, or a digital container provided on a webpage, web application, and/or native mobile application. For example, the user may initiate the eligibility assessment by interacting with digital media displayed through the webpage, web application, and/or native mobile application.

In some cases, the eligibility assessment can be initiated through a user device 120 by transmitting an initiation message to the eligibility assessment server 150. A retailer may display a notification indicating a recipient address corresponding to the eligibility assessment server 150 and an initiation message. For instance, the recipient address may be a short code corresponding to the EAS 150. A user may then transmit the initiation message to the recipient address using a messaging application and/or SMS message. The eligibility assessment server 150 may then provide a response with a uniform resource locator (URL) corresponding to the eligibility assessment application 238. The user can select the URL through the messaging application to initiate the user eligibility assessment.

In some cases, the eligibility assessment can be initiated through a user device 120 by scanning a quick response (QR) code that encodes a uniform resource locator (URL) corresponding to the eligibility assessment application 238. The user device 120 may then access the URL corresponding to the eligibility assessment application 238 to initiate the user eligibility assessment. In general, the QR code may be displayed on any form of printed or digital media. For example, the QR code may be displayed in another user device 120 (e.g., belonging to the merchant) and may, in some cases, be generated in response to and based on information provided by the merchant.

At 312, the eligibility assessment server 150 may identify the device 120 used at 310 to initiate the user eligibility assessment. A device identifier can be associated with the user device 120 used at 310 to initiate the user eligibility assessment.

For example, the eligibility assessment server 150 may identify the mobile device number used to transmit an initiation message at 310. The mobile device number may be used to generate the device identifier associated with the user device 120. The eligibility assessment server 150 may use the device identifier to assess a cyber-security risk associated with the requesting user.

In some examples, the mobile device number of the user device 120 used to initiate the eligibility assessment can be encrypted and/or otherwise obscured in order to generate the device identifier. In some cases, the obscured mobile device number can be included in the URL used to initiate the user eligibility assessment. The EAS 150 may then determine the device identifier associated with the user device 120 from the URL.

Once the user eligibility assessment is initiated at 310, the eligibility viewer application 218 may display an identification interface such as GUI 620 shown in FIG. 6B. The identification GUI 620 may allow a user to provide identifying data through the user device 120 and/or at a retailer location. If a user selects to provide identifying data in person, method 300 proceeds to 314B. Alternately, if a user selects to provide identifying data through the device 120, method 300 can proceed to 314a.

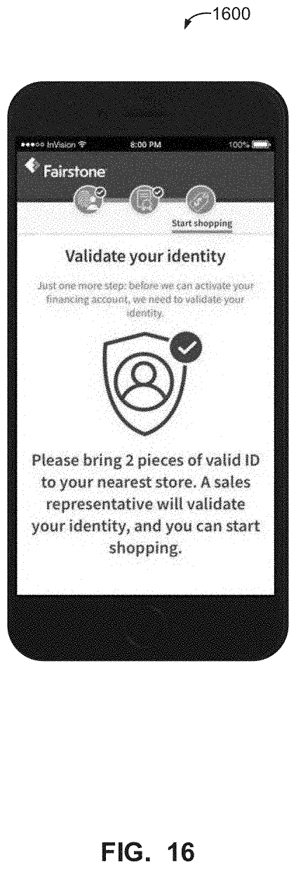

At 314B, the eligibility viewer application 218 may display an in-person identification prompt to the user. The in-person identification prompt may instruct the user to present an identification document, i.e., a form of identification (ID), for validation at a retailer location. The in-person identification prompt may instruct the user to present the identification document in person at a retailer location. The request may include a link to a page or pop-up window with more details on the nature of the ID requirement. GUI 1600 shown in FIG. 16 illustrates an example of an in-person identification that may be provided by the eligibility viewer application 218.

At 320, the eligibility viewer application 218 may present one or more eligibility data input interfaces on user device 120. The eligibility data input interfaces can prompt a user to provide eligibility data necessary to determine user eligibility.

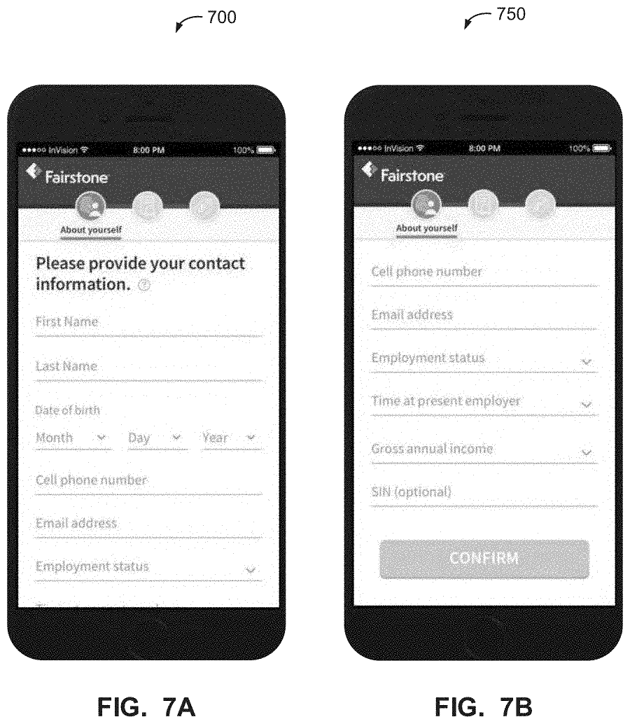

For example, the eligibility viewer application 218 may present one or more eligibility data input forms usable by the user to provide consumer eligibility data. The consumer eligibility data can include consumer demographic data, consumer financial information, consumer credit data, consumer historical credit data and so on associated with the user. The user may interact with the input forms to provide the requested data. Examples of eligibility data input interfaces are shown in FIGS. 7A-12B. Once the user eligibility data is acquired, method 300 can progress to step 324.

Alternately, if a user selects to identify themselves digitally, method 300 can proceed from step 312 to step 314A. At 314A, the user can link the user eligibility assessment with an existing user account. The existing user account can be provided by a specified account provider, which may be different than the entity that operates the EAS 150. Examples of account providers can include financial account providers such as banks, utility vendors, payment providers, and/or social media account providers.

The EAS 150 may provide a list or set of potential account providers. For example, a provider selection interface, such as GUI 640 shown in FIG. 6C, can be provided by the eligibility viewer application 218. The provider selection interface may specify the set of available providers from which a user can select an account.

In some cases, the EAS 150 may limit the set of available providers to providers having specified levels of security. For example, the EAS 150 may limit the set of available providers to financial institutions (e.g. banks) or payment providers that provide a specified level of online account security.

In some cases, the EAS 150 may allow a user to select a provider of their choice. This may provide a user with greater flexibility in selecting the account used to provide user eligibility data. The EAS 150 may evaluate the selected provider to determine a cyber-security risk associated with the selected provider. This cyber-security risk may then be used when assessing user eligibility.

Once the user has selected an existing account provider, the method can proceed to step 316. At 316, the EAS 150 can initiate an open account process to link the user eligibility assessment to the existing user account (and associated eligibility data). The user eligibility data acquired through the open account process can be secured by the existing security procedures maintained by the account provider. User eligibility data may include one or more data items such as name, mailing address, e-mail address, phone number and transaction history (such as a recent transaction history over the previous 90 days).

The user may interact with account access interfaces corresponding to the selected provider through the eligibility viewer application 218. FIGS. 6D and 6E illustrate example GUIS 660 and 680 of account access interfaces that may be provided through the eligibility viewer application 218. As illustrated, the account access interfaces can require the user to provide credentials (e.g. a user name and password) corresponding to the existing account. The account access interfaces can also implement any and all security protocols that are already provided for the existing account, such as additional security questions, two-factor authentication methods etc.

Once the user has successfully provided credentials corresponding to the existing account, the EAS 150 can retrieve the user eligibility data from the account provider. This may provide a simple process for acquiring user eligibility data. This may also ensure that some, or all, of the user eligibility data has already been verified by a reputable third-party.

If the user fails to provide valid credentials for any existing account, the eligibility viewer application 218 may re-direct method 300 to step 314B. The user may then be required to validate their identity in person.

In some embodiments, a user may only be required to provide a physical identification document where they either select to provide the identification data in-person (e.g. using GUI 620) or where insufficient user eligibility data is acquired from the existing account provider (including where the user does not provide appropriate account credentials).

Once the EAS 150 has retrieved user eligibility data from the existing account, method 300 can proceed to step 318.

At 318, the EAS 150 can establish a session identifier. The session identifier can be assigned to the eligibility request initiated through the eligibility viewer application 218 in an ongoing session of communication between the user device 120 and EAS 150. The session identifier can be used to monitor the eligibility assessment to identify any irregularities associated with communications between the user device 120 and EAS 150. This may be used in evaluating the cyber-security risk associated with the requesting user.

In some cases, the method 300 may proceed from step 318 to 320. For example, where additional user eligibility data is required and/or preferred, method 300 may proceed to step 320 to prompt the user to input additional user eligibility data.

Alternately, method 300 may proceed from step 318 to step 322. Method 300 may proceed directly from step 318 to step 322 where the eligibility data received from the external account provider at step 316 is sufficient for the requested eligibility assessment. For example, where the EAS 150 is able to successfully connect to the existing account provider and retrieve sufficient user eligibility data (such as user demographic data and/or historical financial data), the method may proceed to step 322.

At 322, the EAS 150 may evaluate a digital risk associated with the user requesting the eligibility assessment. The digital risk may be evaluated based on various cyber-security related factors associated with the requesting user and/or the user device 120.

For example, user-related factors such as the account provider used to authenticate the user, and the accuracy and scope of user eligibility data provided, may be used to assess the risk associated with identifying the user digitally. For instance, EAS 150 may assign a confidence score to the account provider selected by the user. The confidence score may reflect an estimate of the reliability and accuracy of data received from that account provider. For example, a social media account provider may be assigned a lower confidence score than a financial account provider or utility vendor.

Device-related factors such as the type of device, the device number, and session monitoring data associated with the session identifier may be used to assess the risk associated with identifying the user digitally through that user device 120.

At 324, the EAS 150 can determine the user's eligibility for the requested offer. Eligibility may be determined based on user eligibility data received in conjunction with the eligibility assessment request. For example, the EAS 150 may provide the user eligibility data as inputs to an eligibility assessment model stored by the EAS 150. Eligibility criteria stored by EAS 150 can also be used to assess the user's eligibility.

In some cases, the EAS 150 may determine an initial eligibility score. The initial eligibility score may then be provided to a credit analysis application to provide addition eligibility evaluation. A final eligibility score or assessment may then be determined based on the initial eligibility score and the credit analysis.

At 326, the eligibility determination can be transmitted to the user device 120. The EAS 150 can provide an eligibility notification through the eligibility viewer application 218. The eligibility notification can indicate to the user whether the EAS 150 has determined that the user is eligible for the requested offer.

In some cases, the eligibility notification can include further interactive features or links. For example, where the EAS 150 determines that the user is eligible, the eligibility notification can include an interactive link or button usable to activate the requested offer, or to initiate a process of activating the offer.

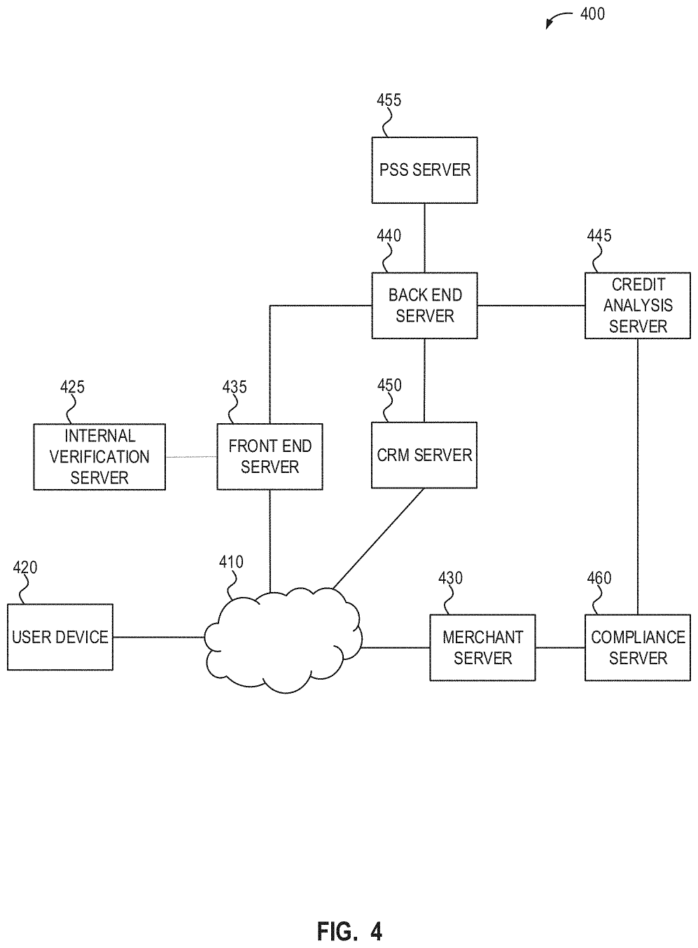

Referring now to FIG. 4, there is provided is a block diagram of an automated real-time online data processing computer network system 400 in accordance with an example embodiment. System 400 illustrates an example of a data processing computer network system in which the operations of the eligibility assessment server 150 are distributed amongst a plurality of servers.

The system 400 generally comprises a plurality of computing devices connected via data communication network 410, which itself may be the Internet, for example. In some cases, there may be multiple links or firewalls, or both, between network 410 and the Internet, or between one or more computing devices of system 400 and network 410. Some organizations may operate multiple networks 410 or virtual networks 410, which can be internetworked or isolated. These have been omitted for ease of illustration, however it will be understood that the teachings herein can be applied to such systems.

Network 410 may be constructed from one or more computer network technologies, such as IEEE 802.3 (Ethernet), IEEE 802.11 and similar technologies.

Each of the computing devices of system 400 may be connected to network 410 (or a portion thereof) or to each other via suitable network interfaces. Computing devices may be any devices capable of data communication, such as desktop computers, portable laptop computers, mobile devices (e.g., smartphones), tablet computers, smart watches, computer servers or others. Computer servers may encompass a combination of hardware and software that, in operation, servers (or manage) computer services accessible via client computers, such as other computer devices. Each computing device may have a processor, volatile memory and non-volatile storage memory, a network interface, an input device such as a keyboard and mouse, output devices such as a display and speakers, and various other input/output devices as will be appreciated.

A user device 420 is a computing device that can connect to network 410 via a wired or wireless data connection. The user device 420 may be operated remotely to connect to the system 400. In some embodiments, the user device 420 may be equipped with an image capture device. The image capture device can be used to scan a quick response (QR) code. In some cases, the image capture device may be used to obtain an image of user identification data, such as a consumer identification card (e.g. a driver's license).

In some cases, the user device 420 can include various type of corresponding biometric components, such as fingerprint scanners, retinal scanners, image capture devices and so on. The user device 420 may be configured to provide biometric identification of a user. For example, the user device 420 may be configured to provide various types of biometric identification, such as picture scanning, and/or facial recognition, and/or fingerprint recognition, and/or retina reading.

In the example illustrated, internal verification server 425 is a computer server that is operably connected to a front end server 435. In some embodiments, the internal verification server 425 may assist with a user eligibility assessment. The internal verification server 425 may provide eligibility assessments as a backup, or alternative, to the examples of automated analyses described herein below.

In the example illustrated, merchant server 430 is a computer server that is operably connected to network 410. The merchant server 430 may be operated by a merchant/retailer interested in providing a financial offer. For example, the merchant server 430 may assist a retailer in offering credit or accepting the use of credit granted via the system 400. As illustrated, the merchant server 430 may be connected to a compliance server 460.

In some examples, the merchant server 430 may be a computer terminal used by a representative of the merchant.

Alternately or in addition, the user device 420 and merchant server 430 may be provided by a single device. For example, a retailer may provide one or more user devices 420 to consumers within a retailer location. Users may interact with the retailer user devices 420 to initiate an eligibility assessment. Once the assessment has been initiated, and user eligibility data has been input by the user, the device 420 may be provided to a retailer user. The retailer user may then operate the device 420 as a merchant terminal, e.g. by inputting credentials that enable the merchant server functionality.

In the example illustrated, front end server 435 is a computer server that is operably connected to network 410. The front end server 435 operates to exchange (e.g., sends and receives) data over the network 410 with the user device 420. Generally, the front end server 435 may be connected to the internal verification server 425 and to a back end server 440.

In the example illustrated, back end server 440 is a computer server that is operably connected to the front end server 435. The back end server 440 can be configured to exchange data with the front end server 435 including, but not limited to, data (e.g. user eligibility data) for use with other computer servers to which the user device 420 does not have direct access, such as record storage server 455 and/or credit analysis server 445. Optionally, the back end server 440 may be connected to a credit analysis server 445, customer relationship management (CRM) server 450, and/or record storage server 455.

In the example illustrated, the credit analysis server 445 is a computer server that is operably connected to the back end server 440. The credit analysis server 445 may be configured to receive user eligibility data from back end server 440 and generate a user eligibility assessment based on the received user eligibility data. For example, the credit analysis server 445 may be a financial application software server for credit card account processing, such as VisionPLUS™ from First Data Corporation. As shown, the credit analysis server 445 can be connected to the compliance server 460.

In the example illustrated, CRM server 450 is a computer server that is operably connected to network 410. CRM server 450 may send automatically generated emails with information generated by elements of system 400, addressed to a user of the user device 420. CRM server 450 is connected to the back end server 440. In at least some embodiments, CRM server 450 may execute a customer relationship management software such as Salesforce™.

In the example illustrated, the record storage server 455 (sometimes referred to as privacy solution system server or “PSS server”) is a computer server that is operably connected to the back end server 440. Record storage server 455 may include a database that records user or customer consent for various purposes, such as mail, e-mail or telephone solicitation consent.

In the example illustrated, the compliance server 460 (sometimes referred to as “FSC server”) is a computer server that is connected to the merchant server 430 and the credit analysis server 445. Compliance server 460 may be a web-based portal to a database, provided for use by merchants when validating identification documents provided by a customer. In operation, the merchant, upon validating an identification document, can record the validation document using the web-based portal. The compliance server 460 therefore can serve to unblock an account and make it available for a customer to start shopping. Compliance server 460 may also maintain an audit trail of certain actions, such as ID validation.

In system 400 the operations of the eligibility assessment server 150 can be distributed amongst the front end server 435, back end server 440, internal verification server 425, pss server 455, credit analysis server 445, crm server 450, and compliance server 460 as discussed herein below. While the system 400 illustrated as having separate front end server 435, back end server 440, internal verification server 425, pss server 455, credit analysis server 445, crm server 450, and compliance servers 460, it should be understood that the functions described in relation to these servers may be distributed amongst one or more servers that can be collocated or connected remotely through a network such as network 110.

Each computing device of system 400, may be a single device, or a combination of devices, although not all are shown. Each of the computing devices may connect to external computing devices via network 410.

For example, each of the computer servers may be constructed from a server farm, which may be in geographically diverse locations, and accessed via a load balancer. Such arrangements are sometimes referred to as “cloud” services. In general, the computer servers may provide one or more software application in the system 400, and may be accessed by one or more device from within network 410 and occasionally from outside of network 410.

Although some of the embodiments describe particular devices, such as computer servers, it will be appreciated that the functionality of certain of these devices may be combined in a single device, or subdivided among additional devices. For example, the record storage server (PSS server) is described as a server computer, however its functionality may be provided by the back end server, or may be provided as a distinct database system provided by the back end server.

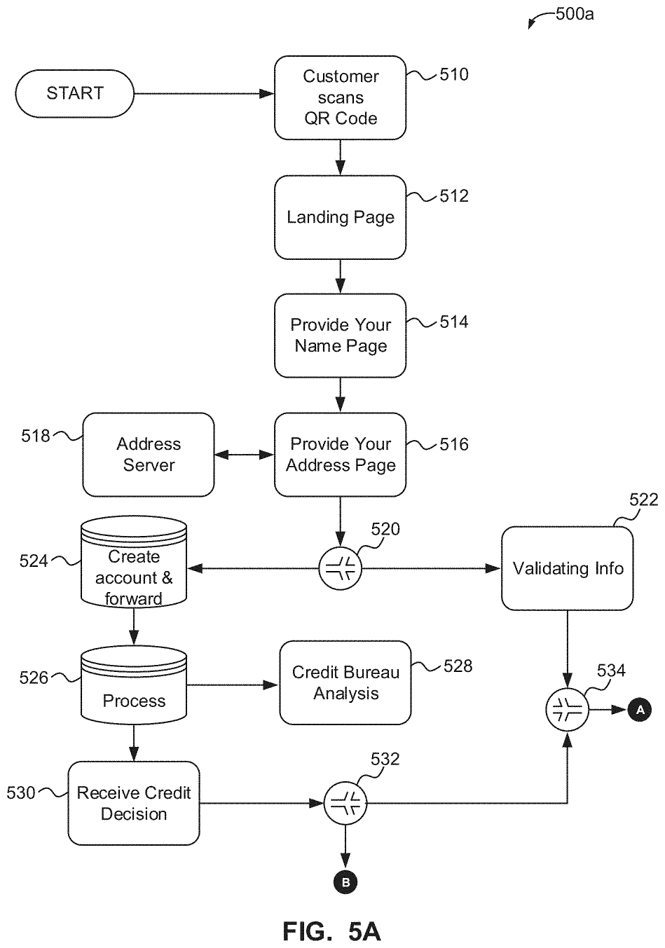

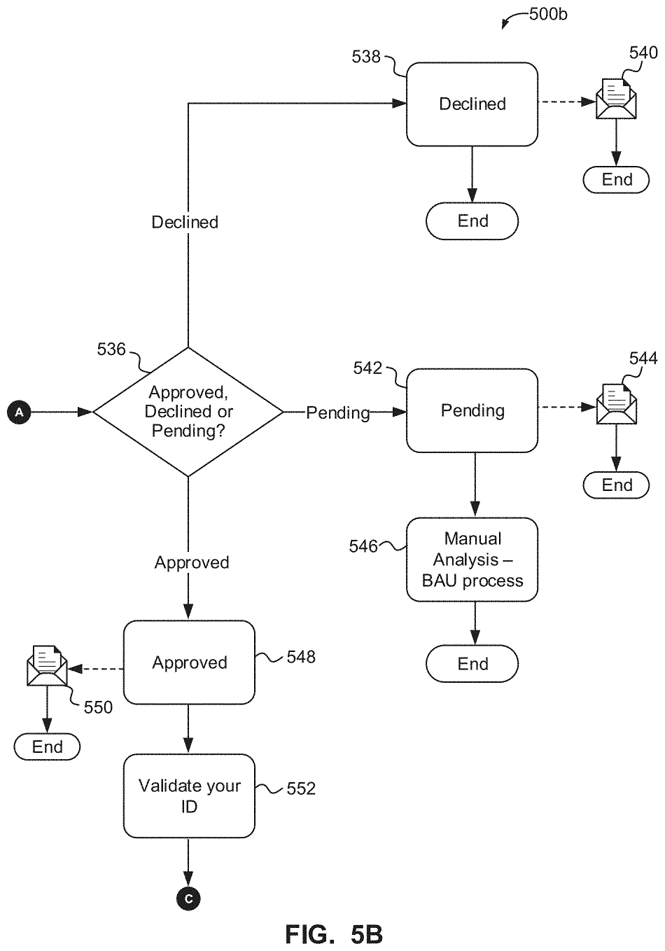

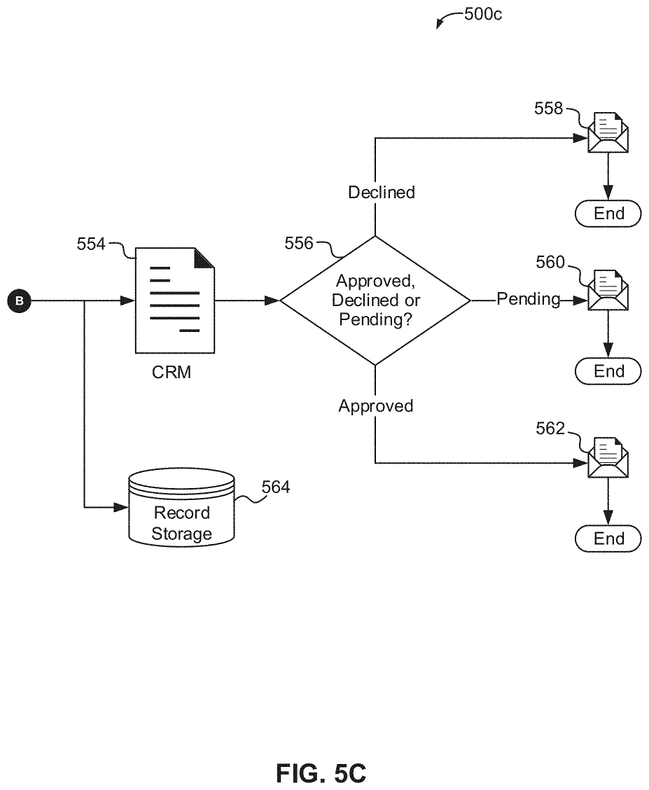

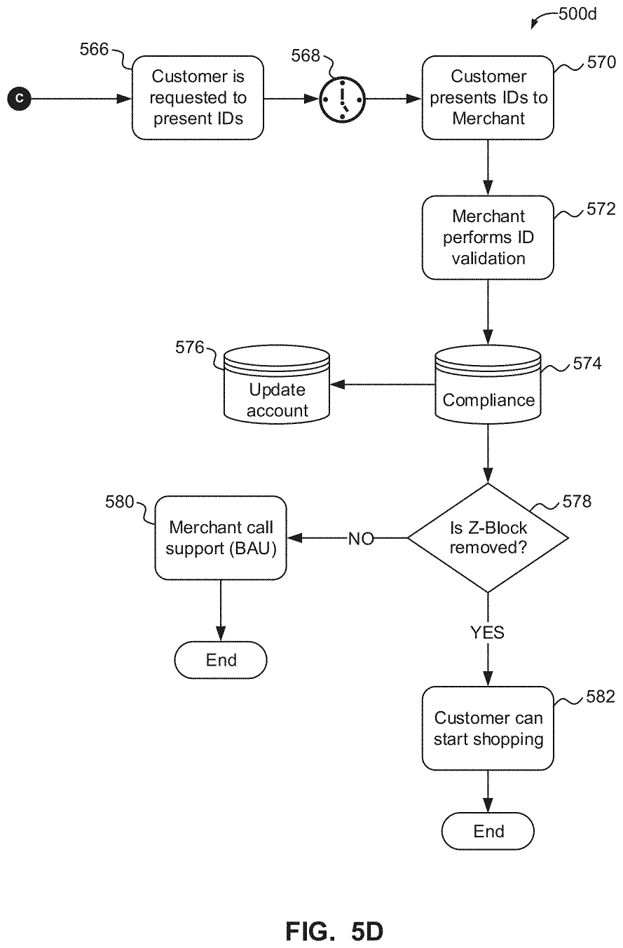

Referring now to FIGS. 5A to 5D, there is shown a flowchart illustrating a computer-implemented method 500 (shown in parts as methods 500a, 500b, 500c and 500d) of automated real-time online credit application processing in accordance with at least some example embodiments. For the purposes of readability only, circles with capital letters within indicate where one part of a flowchart connects to another, such that FIGS. 5A to 5D may be read as one figure. All or portions of method 500 may be implemented on a data processing system such as systems 100, 200 and 400 for example.

At 510, the user device 420 scans a quick response (QR) code that encodes a uniform resource locator (URL). Although method 500 is described in the context of a user scanning a QR code, it should also be understood that method 500 may be initiated at 510 by other means. For example, a URL may be accessed at, or entered into (e.g., typed into), the user device 420. A user may manually type the URL into a browser application operating in the user device 420. Alternately, a user may select a link or digital container from a webpage, web application, and/or native mobile application. Further alternately, a user may transmit a message using a messaging application to a recipient address associated with the front end server 435.

Returning to the example illustrated in FIG. 5A, the QR code may be provided by a web site served by the front end server 435 or, in some embodiments, may be displayed in other ways (e.g., on a printed page). The user device 420 accesses the URL (e.g., as encoded in the QR code) to connect to the front end server 435. The URL may also contain one or more identifier that can be used to direct the access request and/or identify the user subsequently. For example, the URL may include a device identifier, such as an obscured form of the device 420 mobile number. The method 500 proceeds to 512.

At 512, the front end server 435 displays a landing page on the user device 420. The landing page may include a start button, an overview of steps to obtain credit, and a privacy policy link. The method 500 proceeds to 514. An example of the landing page is shown in FIG. 6A. The process illustrated in steps 514-520 of method 500 is a detailed example of the process that may occur in steps 314b and 320 of method 300. Alternately, user eligibility data may be acquired as described above in relation to steps 314-322 of method 300.

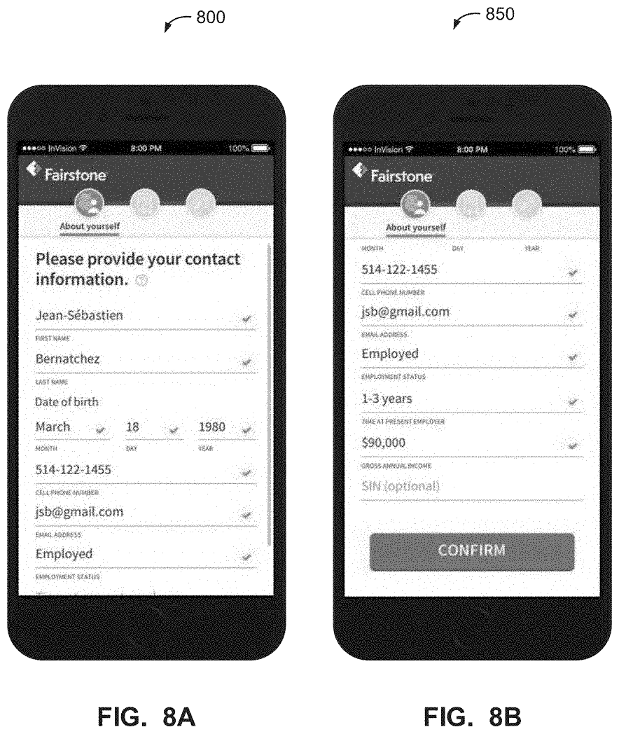

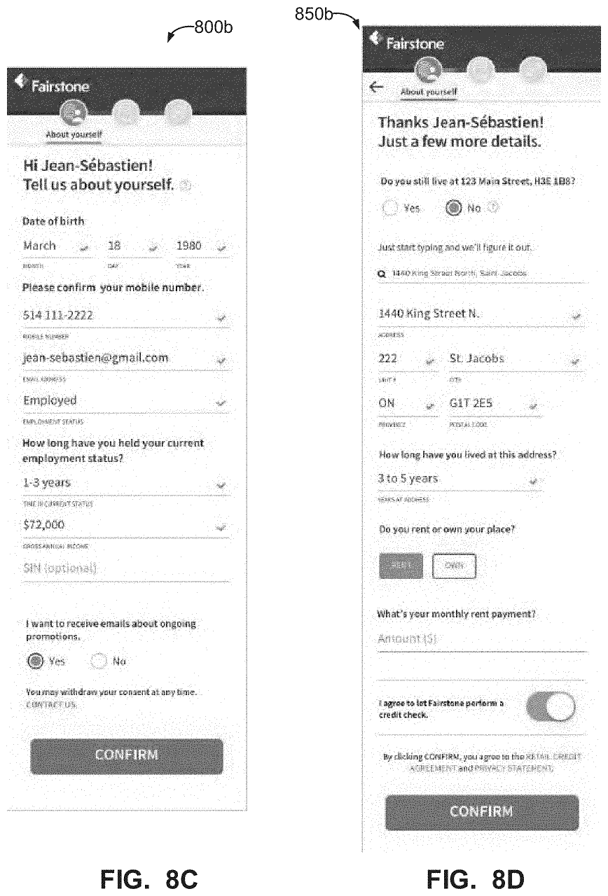

At 514, the front end server 435 displays a page on the user device 420 to enter user eligibility data including user demographic data, such as name information. The page, which can also be referred to as a “user demographic information page” or “user demographic information collection page”, may include other fields, such as for date of birth, phone number, and email address. The front end server 435 may provide an opt-in/opt-out selection. The method 500 proceeds to 516. Examples of the user demographic information collection page before being filled out are shown in FIGS. 7A and 7B. Examples of the user demographic information collection page after being filled out are shown in FIGS. 8A and 8B.

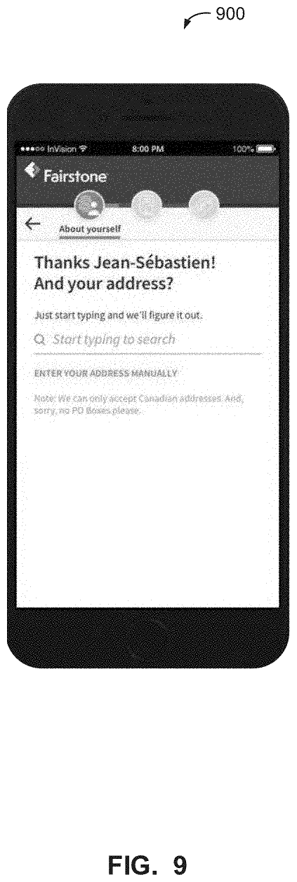

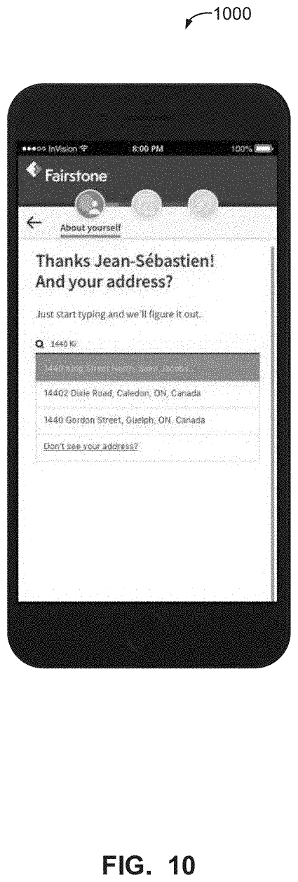

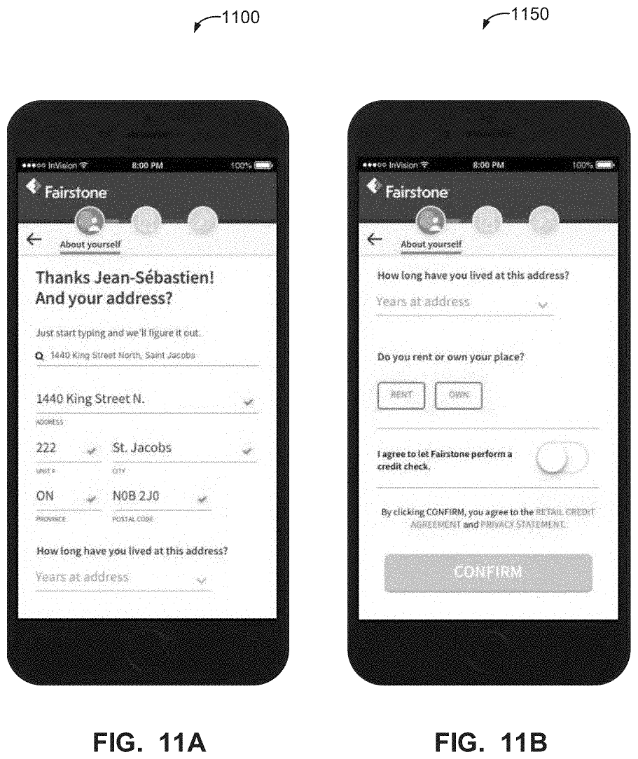

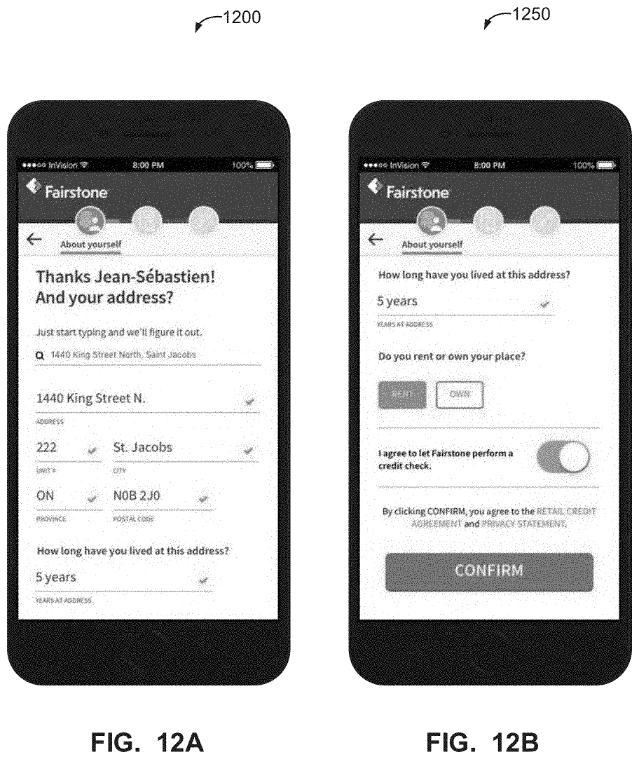

At 516, the front end server 435 displays a page on the user device 420 to enter additional user information, such as an address. The page, which can also be referred to as an “address page”, may employ database suggestions (e.g., auto-complete) to render address entry faster. The front end server 435 may provide a privacy policy link and a retail credit agreement link. The front end server 435 initiates an API call at 518. The method 500 proceeds to 518 and 520. An example of the address entry page before being filled out is shown in FIG. 9. An example of the address entry page when entry begins is shown in FIG. 10. An example of the address entry page when partially filled out is shown in FIGS. 11A and 11B. An example of the address entry page when filled out is shown in FIGS. 12A and 12B.

The front end server 435 may combine 514 and 516 by displaying a user information page on the user device 420 to enter user information. An example of a combined user information page is shown in FIGS. 8C-8D.

At 518, the front end server 435 invokes an API call to an address server (e.g., as provided by a postal) to verify the address. The method 500 returns to 516.

At 520, the method 500 branches with the front end server 435 continuing at 522 and the back end server 440 continuing at 524. The front end server 435 sends the user information (e.g., name, address, etc.) to the back end server 440 for further processing. The front end server 435 may periodically poll the back end server 440 for an update as to whether a response (e.g., a credit decision) is forthcoming within a predetermined period until such time that the back end server 440 provides a response.

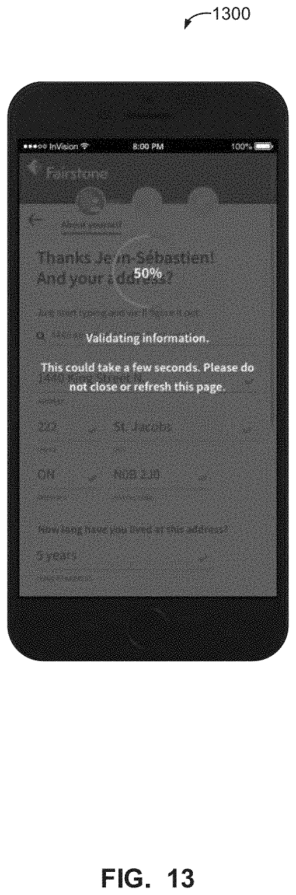

At 522, the front end server 435 may display a notice to the user device 420 that validation may take up to a predetermined amount of time (e.g., 60 seconds). In some cases, the front end server 435 may provide an estimate of the amount of time remaining until validation is complete (e.g., status circle showing a percentage completion). The method 500 proceeds to 534. An example of the validation page displaying a 50% completion estimate is shown in FIG. 13.

At 524, the back end server 440 receives the user information from the front end server 435 and creates a customer account based on the user information. The back end server 440 forwards the user information to the credit analysis server 445. The method 500 proceeds to 526.

At 526, the credit analysis server 445 receives the user information from the back end server 440. The credit analysis server 445 forwards the user information to a third party server, such as a credit bureau server. The method 500 proceeds to 528 and 530.

At 528, the credit analysis server 445 sends a request containing some or all of the user information to the credit bureau server for a creditworthiness analysis (e.g., a “hard check pull”). At 530, the back end server 440 receives a credit decision from the credit analysis server 445 based on the credit check.

At 532, the back end server 440 forwards the credit decision to the front end server 435, the CRM server 450, and the record storage server 455 and method 500 branches with the front end server 435 continuing at 534, the CRM server 450 continuing at 554 (of FIG. 5C), and the record storage server 455 continuing at 564 (of FIG. 5C). In some embodiments, if the credit decision is an approval, the back end server 440 may update the customer account, and instruct the credit analysis server 445 to associate a decline block code (e.g., Z-block) with the customer account until an ID verification can be performed, as described further herein. The back end server 440 may send to the CRM server 450 the user information associated with the user device 420. The back end server 440 may send to the record storage server 455 the communication preferences associated with the user device 420. The back end server 440 may send to the compliance server 460 an account number for the customer associated with the user device 420, if approved.

At 534, the method 500 converges with the front end server 435 receiving information on the response (e.g., credit decision) from the back end server 440. The method 500 proceeds to 536.

Referring now to FIG. 5B, at 536, the front end server 435 identifies whether the credit for the consumer associated with user device 420 was approved, declined, or pending. If declined, the method proceeds to 538; if pending, the method proceeds to 542; if approved, the method 500 proceeds to 548.

At 538, the front end server 435 displays a “Declined” notification message for the user device 420. The method proceeds to 540. Alternatively, the method 500 may end here.

At 540, the front end server 435 sends a notification (e.g., e-mail or push notification) to the user device 420 indicating that the application is declined. The method 500 may end here.

At 542, the front end server 435 displays a “Pending” notification message for the user device 420. The notification message may include a confirmation number and a phone number to call for further details. The front end server 435 sends a message to the internal verification server 425 that the application is pending. The method proceeds to 544.

At 544, the front end server 435 sends a notification (e.g., e-mail or push notification) to the user device 420 indicating that the application is in pending status. The method 500 may end here.

At 546, the internal verification server 425 receives the message from the front end server 435 that the application is pending. The internal verification server 425 notifies a credit team that manual analysis (e.g., a business-as-usual (BAU) process) is to be used. The method 500 may end here.

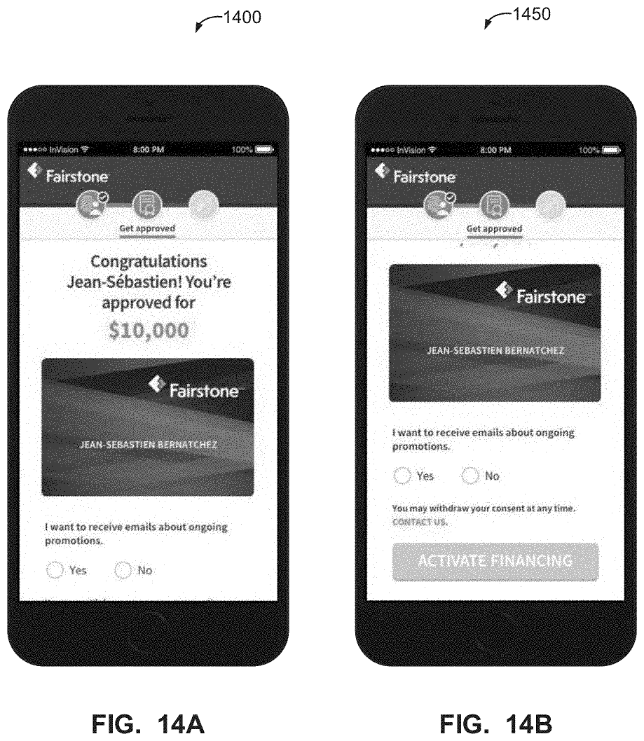

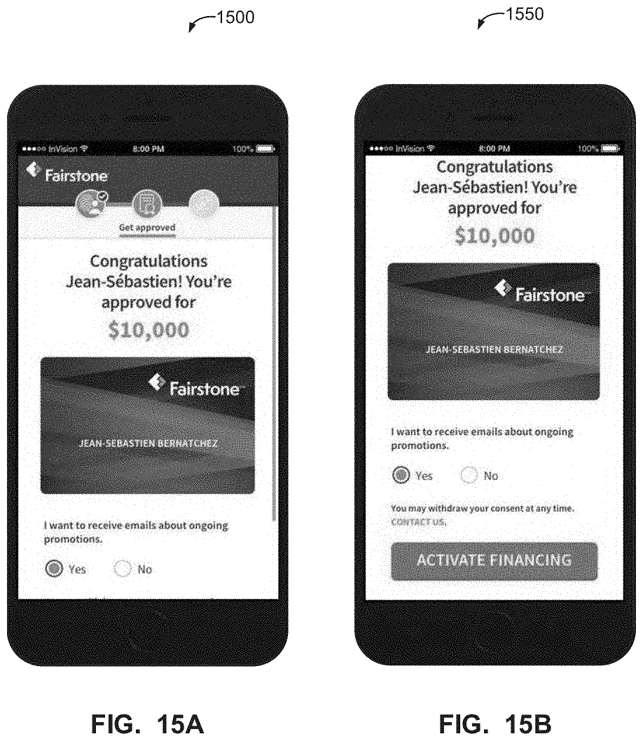

At 548, the front end server 435 displays an “Approved” notification message for the user device 420. The notification message may include the amount of credit approved and a button to engage an “Activate Financing” operation. The method 500 proceeds to 552. An example of the “Approved” page with the “Activate Financing” button disabled is shown in FIGS. 14A and 14B. An example of the “Approved” page with the “Activate Financing” button enabled is shown in FIGS. 15A and 15B.

At 550, the front end server 435 sends a notification (e.g., e-mail or push notification) to the user device 420 indicating that the application is approved. The method 500 may end here in some cases.

At 552, the front end server 435 generates a request for the user device 420 instructing a user of the device to provide an identification document, i.e., a form of identification (ID), for validation. For example, the user may be requested to take a photo of the identification document and forward it to a merchant, or merchant server. Or the user may be requested to present the identification document in person to a merchant. The request may include a link to a page or pop-up window with more details on the nature of the ID requirement.

In some cases, the user may be required to provide biometric identification data to authenticate their identity. The biometric identification data can include facial recognition data, fingerprint recognition data, retinal reading data and so forth. User device 420 may prompt the user to provide the biometric identification data, e.g. through a facial recognition device or application, a fingerprint scanning device or application, and/or a retinal scanning device or application.

In some cases, the user may be requested to provide a personal photograph in conjunction with a photo of the identification document. This may allow the identity of the requesting user to be correlated with the identification document and validated.

The method 500 proceeds to 566. An example of the identity validation request page is shown in FIG. 16.

Referring now to FIG. 5C, at 554, the CRM server 450 receives the user information and credit decision from the back end server 440. The method 500 proceeds to 556.

At 556, the CRM server 450 identifies whether credit was approved, declined, or pending. The CRM server 450 sends a message containing the results to the user device 420. If declined, the method 500 proceeds to 558; if pending, the method 500 proceeds to 560; if approved, the method 500 proceeds to 562.

At 558, the CRM server 450 generates a notification (e.g., e-mail or push notification) for the user device 420 indicating that the application is declined. The method 500 may end here.

At 560, the CRM server 450 generates a notification (e.g., e-mail or push notification) for the user device 420 indicating that the application is in pending status. The method 500 may end here.

At 562, the CRM server 450 generates a notification (e.g., e-mail or push notification) for the user device 420 indicating that the application is approved. The method 500 may end here.

At 564, the record storage server 455 receives information from the back end server 440 regarding the customer's communication preferences and records the information (e.g., user consent to receive solicitations).

Referring now to FIG. 5D, at 566, the user device 420 receives a notification from the front end server 435 that ID validation is required. The user device 420 displays a message asking the customer to present identification. The method 500 proceeds to 568.

At 568, the user device 420 waits for identification input from the customer. In some embodiments, identification input may be a photo of an identification document, such as driver's license, passport or other photo identification, utility bill, banking information, tax statement, etc. In some embodiments, identification input may be a photo of the user, taken with the user device 420, or other biometric identification data. In still other embodiments, identification input may be a combination of one or more of these examples, or other forms of input. For security purposes, in some embodiments, the front end server 435 may timeout the user device 420 after a predefined period of time (e.g., 2 minutes). The method 500 proceeds to 570.

At 570, the user device 420 receives the identification input from the customer and sends it to the merchant server 430. Alternatively, in some embodiments, the user presents an identification document to a merchant in person. The method 500 proceeds to 572.

At 572, the merchant server 430 receives the customer identification input from the user device 420 and performs ID validation. The merchant server 430 sends the results of the ID validation to the compliance server 460. Alternatively, the merchant validates the presented identification document, and accesses a web portal provided by the compliance server 460 to complete ID validation. The method 500 proceeds to 574.

At 574, compliance server 460 receives the results of the ID validation from the merchant or merchant server 430. These results may serve as an audit trail. The compliance server 460 sends the validated identification to the credit analysis server 445. The compliance server 460 may indicate to the merchant server 430 that it is communicating with the credit analysis server 445. The method 500 proceeds to 576 and 578.

At 576, the credit analysis server 445 receives the validated identification from the compliance server 460. The credit analysis server 445 may update the customer account with the back end server, remove the decline block code, and/or add notes. The credit analysis server 445 returns the results of processing the customer account to the compliance server 460. The method 500 proceeds to 578.

At 578, the merchant or merchant server 430 determines whether the decline block code has been removed. If the decline block code has been removed, the merchant or merchant server 430 may notify the user device 420 of the removal and permit the user device to continue a transaction, and the method 500 proceeds to 582. If the decline block code is not removed, the method 500 proceeds to 580.

In some embodiments, the credit analysis server 445 may update the back end server to indicate that the decline block code has been removed, and the back end server or front end server may notify the user device accordingly.

At 580, the merchant determines, or the merchant server 430 indicates, that the merchant needs to call support (BAU). The method 500 may end here.

At 582, the user device 420 receives the notification from the merchant server 430 (or front end or back end server) that the decline block code is removed and that the credit may now be used. The user device 420 displays that permission to initiate a purchase transaction is granted. The method 500 may end here.

, the process flow may be carried out by a user device, a merchant or merchant device, a front end server, a back end server, a credit analysis server, a CRM server, a compliance server and a record storage server. The acts performed by each of these elements are indicated in the flow diagram by their placement within rows corresponding to each element.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. The scope of the claims should not be limited by the preferred embodiments and examples, but should be given the broadest interpretation consistent with the description as a whole.

We claim:

1. A method of automated real-time online data processing, the method comprising:
providing a user data request page to a remote user device, wherein the user data request page is configured to prompt submission of user eligibility data from the user device;
receiving the user eligibility data from the user device;
sending the user eligibility data to a back end server to perform a user eligibility analysis;
within a predetermined period, receiving an eligibility response based on the user eligibility analysis from the back end server;
sending the eligibility response to the user device;
when the eligibility response indicates that the user eligibility was successful within the predetermined period:
sending a validation request to the user device;
receiving a validation input from the user device or a merchant device; and
notifying the user device of the validation; and
when the eligibility response indicates that the user eligibility was not successful within the predetermined period, forwarding the user eligibility data to an internal verification server for further analysis.

2. The method of claim 1, wherein the validation request includes a request to provide user identification, further comprising:
receiving an update from the merchant or merchant server based on a validation of an identification document; and
notifying the user device of the validation.

3. The method of claim 1, further comprising invoking an API call to an address server to verify an address component of the user eligibility data.

4. The method of claim 1, further comprising sending the eligibility response to a record storage server.

5. The method of claim 1, further comprising:
sending at least a portion of the user eligibility data to an external evaluation server; and
receiving an external eligibility assessment from the external evaluation server.

6. The method of claim 5, wherein the external evaluation server is a credit analysis server, further comprising receiving a creditworthiness evaluation from the credit analysis server.

7. The method of claim 1, further comprising:
sending the identification data to a compliance server;
receiving verification of the identification from the credit analysis server;
receiving notification whether a decline block code is removed; and
when the decline block code is not removed, notifying the merchant server that validation is not successful.

8. The method of claim 1, further comprising evaluating a cyber-security risk associated with a user device used to initiate the eligibility assessment, and adjusting the results of the user eligibility assessment in response to the determined cyber-security risk associated with the user device.

9. An automated online real-time data processing system, the system comprising:
a front end server on a network connected to a user device, the front end server comprising a memory, at least one network interface, and a processor coupled to the memory for electronic communication therewith, the processor configured to:
provide a user information page to receive user information from the user device;
send the user information to a back end server to perform further processing;
within a predetermined period, receive a response based on the further processing from the back end server;
send the response to the user device.

10. The system of claim 9, wherein the processor is further configured to:
when the response indicates that the further processing was successful within the predetermined period:
send a request to the user device to provide identification;
transmit a request to the user device for an identification document;
receive an update from the compliance server based on a validation indication received by the compliance server from the merchant or merchant server; and
notify the user device of the validation.

11. The system of claim 9, wherein the processor is further configured to:
when the response indicates that the further processing was not successful within the predetermined period:
determine that additional processing of the user information is to be performed; and
send an indication of the user information to an internal verification server.

12. The system of claim 9, wherein the processor is further configured to invoke an API call to an address server to verify an address component of the user information.

13. The system of claim 9, wherein the processor is further configured to send the response to a record storage server.

14. The system of claim 9, wherein the processor is further configured to send the name and address to a credit analysis server.

15. The system of claim 9, further comprising:
a merchant server configured to send the identification to an compliance server;
the back end server configured to:
receive verification of the identification from the credit analysis server;
receive notification whether a decline block code is removed; and
when the decline block code is not removed, notify the merchant server that validation is not successful.

16. A non-transitory computer readable medium storing computer program instructions, which when executed by a processor, cause the processor to perform a method of automated real-time online data processing, the method comprising:
providing a user data request page to a remote user device, wherein the user data request page is configured to prompt submission of user eligibility data from the user device;
receiving the user eligibility data from the user device;
sending the user eligibility data to a back end server to perform a user eligibility analysis;
within a predetermined period, receiving an eligibility response based on the user eligibility analysis from the back end server;
sending the eligibility response to the user device;
when the eligibility response indicates that the user eligibility was successful within the predetermined period:
sending a validation request to the user device;
receiving a validation input from the user device or a merchant device; and
notifying the user device of the validation; and
when the eligibility response indicates that the user eligibility was not successful within the predetermined period, forwarding the user eligibility data to an internal verification server for further analysis.
